(19) United States
(12) Patent Application Publication
(10) Pub. No.: US 2016/0212078 A1
(43) Pub. Date: Jul. 21, 2016

(54) Method And System For Managing Mass Delivery Of Audio Messages

(71) Applicant: Voysecast, LLC, Fairfax, VA (US)

(72) Inventors: Millicent Smith, Fairfax, VA (US); Fabian Smith, Fairfax, VA (US); Jennifer Rullmann, Vienna, VA (US)

(21) Appl. No.: 14/996,849

(22) Filed: Jan. 15, 2016

Related U.S. Application Data
(60) Provisional application No. 62/104,363, filed on Jan. 16, 2015.

(51) Int. Cl. H04L 12/58; G06F 17/30; H04W 4/00; H04L 29/08; H04W 8/20

(52) U.S. Cl. CPC H04L 51/10; H04L 67/02; H04L 67/1097; H04W 8/20; H04L 51/32; H04W 4/001; G06F 17/30752

(57) ABSTRACT

In some embodiments, systems and methods disclosed herein facilitate mass delivery of audio messages to communication devices operated by recipients. Such a platform can function as an intermediary between a provider and one or more recipients of the audio message. These messages can be delivered to multiple phones, i.e., landline phones, cellular phones as well as internet (“soft”) phones. In another example, an audio message from a provider can be published on a webpage hosted by a social media network. In some instances, these messages can be delivered to local numbers, long distance numbers, or international numbers. The mass delivered audio messages can be received by users regardless of their geographical location, or the device(s) used to receive the message. Further, the disclosed system can enable users to receive such audio messages without downloading a mobile application program.

### CROSS-REFERENCE TO RELATED APPLICATIONS

This application claims priority to U.S. Provisional Application No. 62/104,363 filed Jan. 16, 2015, and titled “Method And System For Managing Mass Delivery Of Audio Messages,” which is incorporated herein in its entirety by reference for all purposes.

### TECHNICAL FIELD

The present disclosure generally relates to systems and methods for facilitating mass delivery of audio messages. In particular, the present disclosure relates to recording, assembling, and delivering short audio messages on one or more social media networks, on users' communication devices, or a combination thereof.

### BACKGROUND

In many instances, it may be advantageous to automate delivery of pre-recorded audio messages to others. Examples of such scenarios can include public-service or emergency announcements made by authorities, mass phone campaigns by telemarketers, speeches or public policy announcements made by political parties or candidates running for public office, statements by advocacy groups, notices, memos or announcements by companies or organizations to their employees, product news or advertisement campaigns sent to online followers and friends of an organization, public announcements by school authorities to parents and students, etc. Upon receiving such pre-recorded audio messages, recipients of the message may wish to respond back to the provider or source of the audio message. Thus, it would be desirable to facilitate a user's ability to receive audio messages from a provider, and further have the ability to respond to such messages in a simple, easy to use, and effective manner.

### SUMMARY

The present disclosure relates to a telecommunications platform that manages mass delivery of audio messages. Such a platform can function as an intermediary between a provider and one or more recipients of the audio message. No limitations are imposed on the number of recipients of the audio message. For example, an audio message from a provider can be delivered to multiple phones, i.e., landline phones, cellular phones as well as internet (“soft”) phones. In another example, an audio message from a provider can be published on a webpage hosted by a social media network. In some instances, these messages can be delivered to local numbers, long distance numbers, or international numbers. The mass delivered audio messages can be received by users regardless of their geographical location, or the device(s) used to receive the message. Further, the disclosed system can enable users to receive such audio messages without downloading a mobile application program.

The disclosed telecommunications platform can enable a user to record a live audio message via a website or an app running on a user's mobile device. In some embodiments, a user can upload an audio file including the message. The platform additionally may be configured such that a user can call a phone number associated with the platform and record an audio message. These messages can be shared on one or more webpages on social media networks, or distributed to communication devices of users, or a combination thereof.

The messages can be made available to message recipients at a website accessible via a web browser, without the need to download the audio message to the message recipient's device. These messages can be forwarded, shared, embedded and linked to, email addresses and web pages. Such web pages can be linked to social media networks affiliated with a person or an organization. For example, a first message can be delivered to a user's career profile on a first social media network, and a second message can be delivered to a user's dating profile on a second social media network. In some embodiments, audio messages delivered to a social media network are able to support metadata such as text boxes, hash tags, handles, or any other metadata content associated with a social media network. The present system can enable customization of an audio message according to different publishing standards (rules) and delivery protocols of social media networks. In some embodiments, the disclosed platform provides integration with various features (such as Twitter Player Audio Cards, for example), media players, and functionalities of social media networks. For example, publishing rules and audio file formats can vary from one social media network to the other.

The disclosed telecommunications platform may be configured to normalize data prior to publishing a user's audio recordings. Data normalization can allow a user's audio recording, metadata information pertaining to the audio recording, and user-supplied information to be fed into a host of social media networks having disparate (heterogeneous) provisions for receiving, storing, manipulating, and publishing data. In some examples, normalization can include re-sampling (i.e., upsampling or downsampling) of the audio recording to a predetermined format (as specified by a social media network protocol) in order to publish the audio recording on a webpage hosted by the respective social media network.

### BRIEF DESCRIPTION OF THE DRAWINGS

Embodiments of the present technology will be described and explained through the use of the accompanying drawings.

FIG. 1 illustrates an example telecommunications platform for delivery of audio messages, according to an embodiment of the present invention.

FIG. 2A illustrates an example system architecture of an embodiment of the telecommunications platform.

FIG. 2B illustrates an example screen of an interface for a user to record and publish an audio message using an embodiment of the telecommunications platform.

FIG. 3 illustrates an exemplary screenshot of an interface in which a user can record an audio message and deliver the recorded message to intended recipients via their communication devices.

FIG. 4 illustrates an example screen of an interface in which an audio message is published on a webpage of a social media network using an embodiment of the telecommunications platform.

FIG. 5 is a flow diagram showing a sequence of computer-implemented steps for automated delivery of an audio message using an embodiment of the telecommunications platform.

The drawings have not necessarily been drawn to scale. For example, some components and/or operations may be separated into different blocks or combined into a single block for the purposes of discussion of some of the embodiments of the technology of the present application. Moreover, while the technology is amenable to various modifications and alternative forms, specific embodiments have been shown by way of example in the drawings and are described in detail below. The intention, however, is not to limit the scope of the application to the particular embodiments described. On the contrary, the application is intended to cover all modifications, equivalents, and alternatives falling within the scope of the technology as defined by the appended claims.

### DETAILED DESCRIPTION

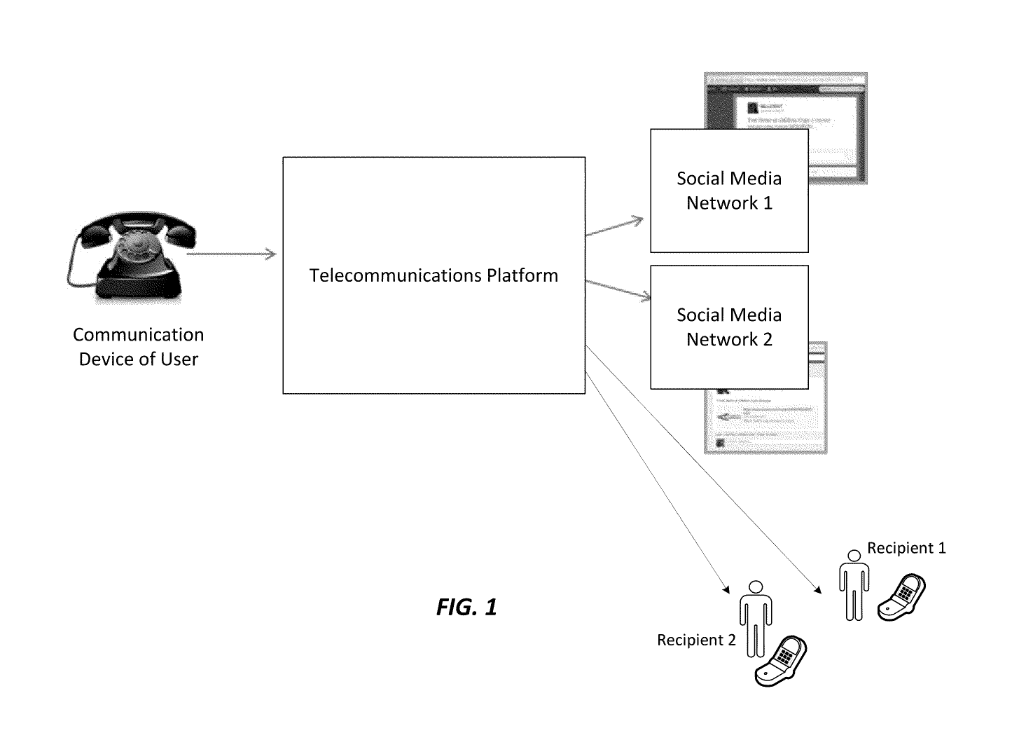

FIG. 1 illustrates an exemplary telecommunications platform that receives an audio message from a communication device of a user and publishes or delivers to two social media networks, a social media network 1 and a social media network 2. It will be understood and appreciated that the present system imposes no limitations on the number of communication devices, device types, brands, vendors and manufacturers that may be used with embodiments of the present disclosure steps. Further, embodiments of the present telecommunications platform can deliver audio messages to any number of social media networks.

In some embodiments, the telecommunications platform is able to facilitate mass delivery of audio messages to communication devices operated by recipients. Such a platform can function as an intermediary between a provider and one or more recipients of the audio message. For example, as shown in FIG. 1, a recipient 1 and a recipient 2 receive (on their communication devices) an audio message delivered by the telecommunications platform. However, in alternate embodiments, no limitations are imposed on the number of recipients of the audio message. For example, an audio message from a provider can be delivered to multiple phones, i.e., landline phones, cellular phones as well as internet (“soft”) phones. Although not shown explicitly in FIG. 1, in some embodiments, the telecommunications platform is able to communicate with the Public Switched Telephone Network (PSTN) in connection with receiving as well as sending audio messages. Further, it will be understood that embodiments of the disclosed telecommunications platform is able to facilitate mass delivery of audio messages in addition to, or in lieu of, publishing of audio messages on webpages hosted by social media networks.

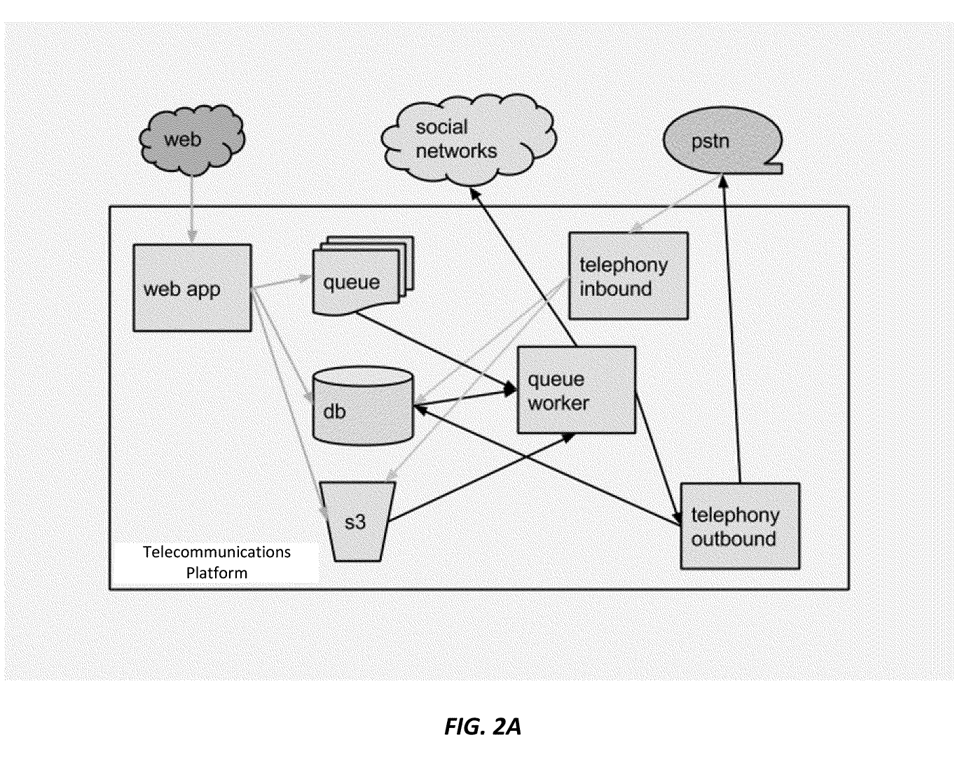

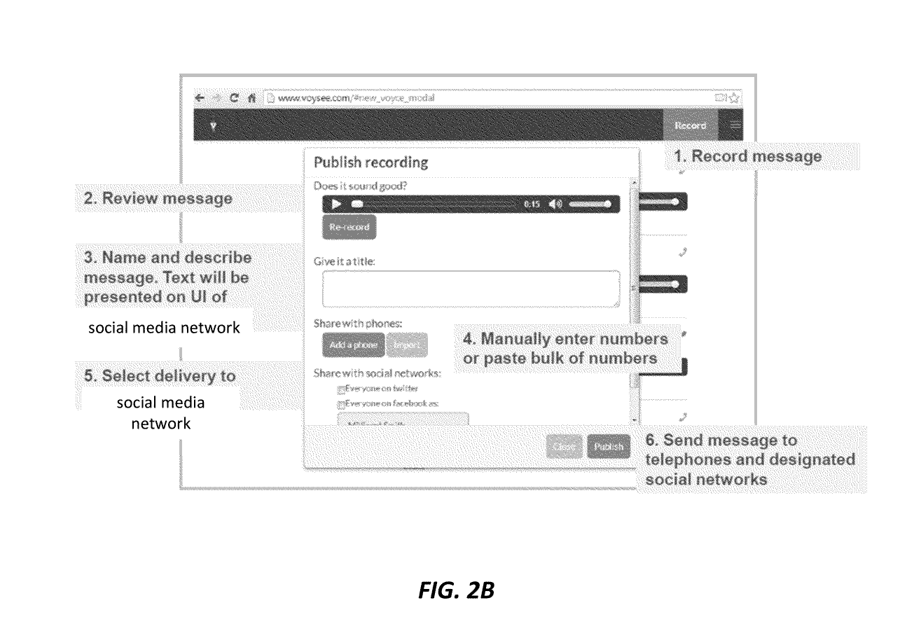

FIG. 2A illustrates an exemplary system architecture of an embodiment of the telecommunications platform. For purposes of example and explanation, it can be assumed that users initially register and create an account or membership with the telecommunications platform. The registration (usually a one-time activity) can be accomplished in a conventional manner via a server user interface, or via a mobile device application program that communicates with the telecommunications platform. In some embodiments, users do not need to register with the telecommunications platform, but can directly login into the platform using their social media network membership credentials. Typically, as will be understood, information provided by system users directly (or, by social media networks indirectly about a user) during registration is stored in an exemplary database associated with an embodiment of the telecommunications platform.

When a returning user is logged into the platform, the platform requests the user to provide a recording of an audio message. In some embodiments, the platform enables a user to record a live audio message via a website or an app running on a user's mobile device. In some embodiments, a user is able to upload an audio file including the message. Upon recording a message, the platform displays a page that provides functionalities to the user to replay the message or re-record the message if the user wishes to do so. Then, the platform (via the displayed page) requests the user to provide one or more recipients of the audio message. The recipients can be, for example, one or more telecommunication devices operated by users or, one or more webpages hosted by one or more social media networks. If the recipients are telecommunication devices, the user can supply a list of phone numbers associated with such devices either by directly typing a list on the displayed webpage or by uploading a file comprising a list of phone numbers corresponding to the one or more telecommunication devices. As will be understood, the communication devices can be owned and operated by individuals and/or entities.

In some instances, the platform also enables users to provide descriptor text (e.g., within a text box) or a title that describes or provides a caption to an audio message. After receiving a recording of an audio message, the platform waits for the user to confirm a request to submit the message (along with accompanying user-supplied information via the webpage, for example) to the platform. In some exemplary embodiments, a user can call a phone number associated with the platform and record an audio message with an interactive voice recognition (IVR) system managed by the telecommunications platform.

Upon receiving the user's audio message via the webpage (along with accompanying user-supplied information), or via the interactive voice recognition system, the platform assigns an identifier to the audio message. The assigned identifier is recorded in a database. If the telecommunications platform determines that the user has provided one or more telecommunication devices as the intended recipients, the platform adds the list of phone numbers to a queue for batch processing. In some embodiments, the queue handles the sequence of calling the intended recipients. In some embodiments, the telecommunications platform can store the entirety or a portion of the data received from (or, related to) users in different databases. For example, the audio recording can be stored in a first database, and the assigned identifier can be stored in a second database. Either or both the first and the second database can be owned by the entity operating the telecommunications platform. Alternately, in some embodiments, either or both the first and the second database can be owned by third parties (e.g., Amazon Web Services).

As shown in FIG. 2A, after an identifier is assigned and stored, the telecommunications platform adds the identifier of a recorded audio message to a queue. A queue worker, or more generally a software program running on the telecommunications platform then pulls the identifier from the queue, collects data from the database, and pushes the audio message to social media networks and/or the public switched telephone network (PSTN) as necessary.

In some embodiments, an audio message recorded by a user is published on a website coupled to the telecommunications platform. Thus, for example, a user who wishes to publish an audio message can optionally choose to publish his or her audio message on a website coupled to the telecommunications platform. This would enable the user to share a link to the user's audio recording via email, SMS, or MMS messaging with other persons. In some instances, the audio message is available publicly on the website via the world wide web. The message can be published on a website in conjunction with being published on a social media network. In some other instances, the telecommunications platform provides a user with access control privileges managed by the user. Such access control privileges would allow the user which person or persons can access the user's audio recording.

In some embodiments, the telecommunications platform includes various instances, or simply components. There can be several counts of instances running in an embodiment of the telecommunications platform. Examples of various instances included in an embodiments of the telecommunications platform can be a deployment instance, a publish instance, a telephony instance, a web instance, and a data structure configuration instance. A deployment instance such as Ansible script (an open-source software tool) is used to bootstrap and deploy various parts of the telecommunications platform. A web instance allows users to register, connect social media networks, and record audio messages via a website hosted by the telecommunications platform. A data structure instance such as a config.yaml instance specifies various parameters that can be configured according to a user's preference. Example of a parameter can be a user's cell phone number or a land line number, based on the user's preference. There is no limitation on the number of recipients, or the number of different phones (e.g., for a given user), that can receive the recorded audio messages. Various other instances providing different functionalities can be included in embodiments of the disclosed platform. There is no limitation on the number of instances of a telecommunication platform. In some embodiments, a web platform works in conjunction with the telecommunication platform. The web platform, for example, receives audio messages recorded by users and publishes on webpages hosted by social media networks. The web platform, in some embodiments, can be designed as a virtual machine or an emulation of a computer system that can replicate and automatically initiate new instances as needed.

In some embodiments, the telecommunications platform is able to perform load balancing by adjusting the functionalities of, either alone or in combination with counts of the various instances included in the telecommunications platform. For example, if the telecommunications platform is receiving a heavy web traffic (e.g., a large number of users are visiting a webpage hosted by the telecommunications platform), the telecommunications platform can automatically increase the number of web instances while reducing the number of telephony instances. On the other hand, if a large number of audio messages are being received by the telecommunications platform, then the number of telephony instances can be increased.

In some embodiments, the telecommunications platform receives an audio message from a user via an inbound telephony system connected to the PSTN. Thus, a call that originates from the PSTN comes to the telephony inbound, which is then conveyed to one or more databases. After the message is saved as a digital file in the databases, the processing steps are similar as those described in connection with an audio message received via the web app.

FIG. 2B illustrates an exemplary screenshot of an interface for a user to record and publish an audio message using an embodiment of the telecommunications platform. Also shown in this screenshot are an exemplary sequence of steps performed by users in connection with recording and publishing an audio message on social media networks, or distributing to communication devices of users, or a combination thereof.

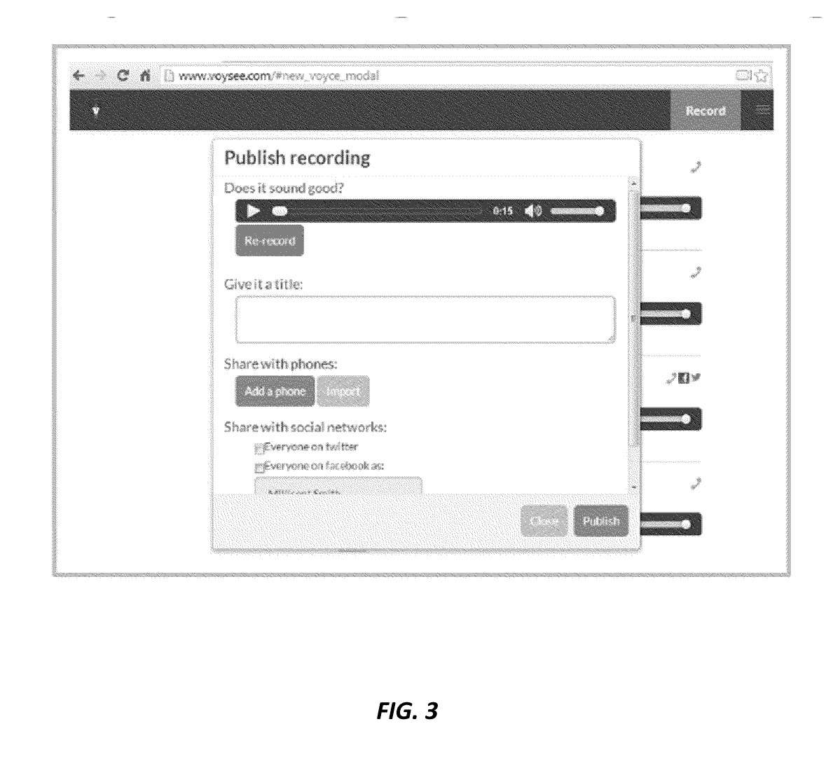

FIG. 3 illustrates an exemplary screenshot of an interface in which a user can record an audio message and deliver the recorded message to intended recipients via their communication devices. As shown in FIG. 3, a user can review a recording, re-record if needed, give a title to a recording, deliver the recording to multiple phones, publish the recorded message on one or more social media networks, etc. In alternate embodiments, various other options can be offered (via the interface) to users of the telecommunications platform.

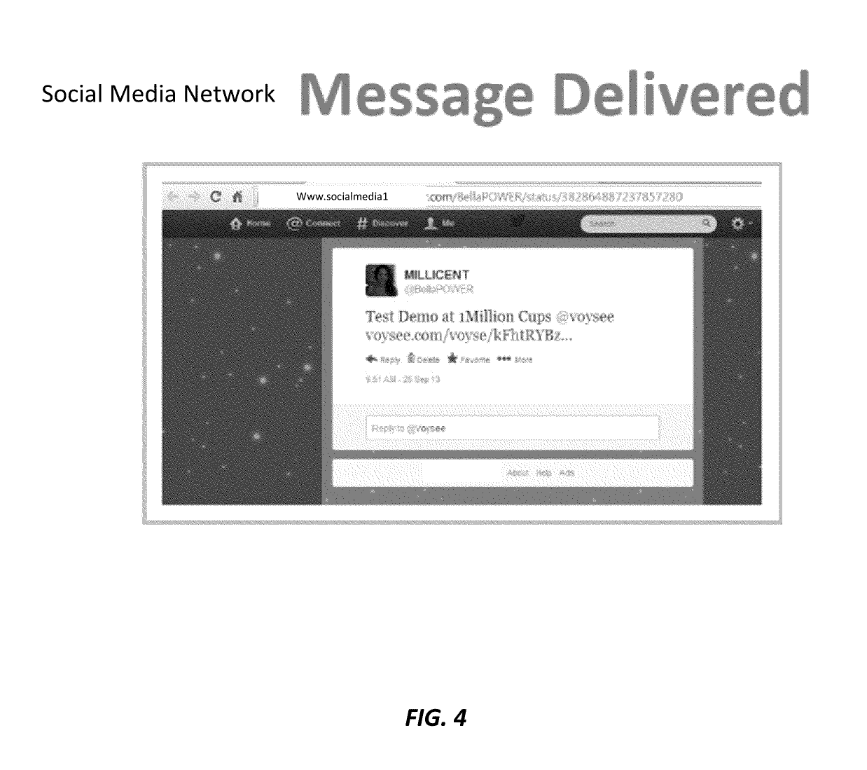

FIG. 4 illustrates an exemplary screenshot of an interface in which an audio message is published on a webpage published by a social media network. As shown in FIG. 4, a hypothetical social media network called “social media 1” has published an audio message called “test demo at 1 million cups” on the webpage of a user “Millicent” on 25 September 2013 at 9:51 AM. A social media network member reviewing this webpage can reply, delete, add to favorite, or perform other actions on this audio message, as exemplarily depicted in FIG. 4.

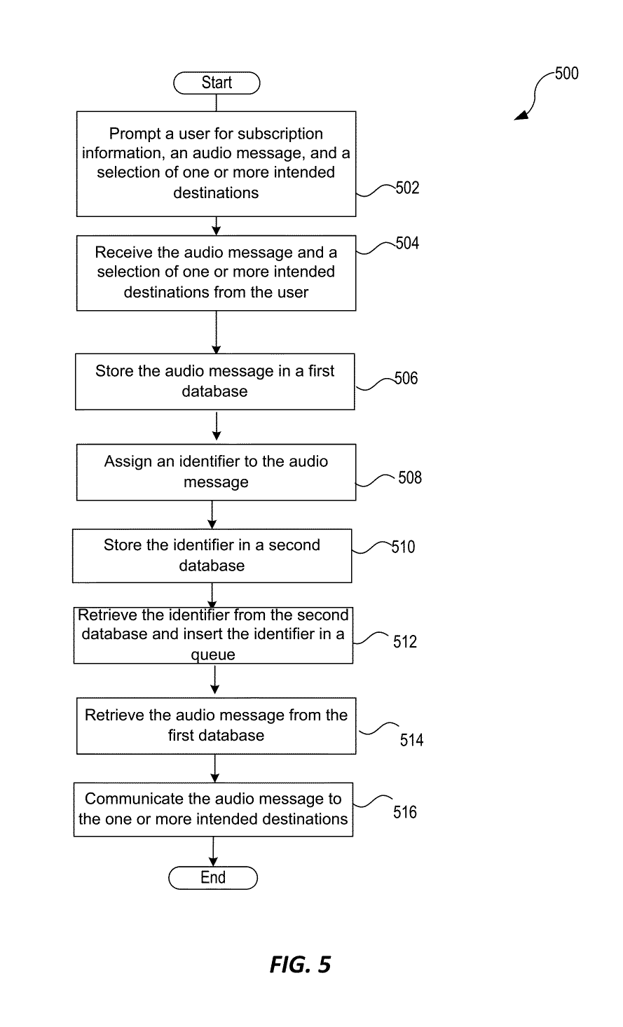

FIG. 5 is a flow diagram showing a sequence of computer-implemented steps for automated delivery of an audio message using an embodiment of the telecommunications platform. Starting at step 502, the telecommunications platform prompts a user for subscription information, an audio message that is to be delivered, and a selection of one or more intended destinations for delivery of the audio message. For example, the one or more intended destinations can be a landline phone, a cellular phone, a soft phone, a social media network. Upon successfully verifying or validating the subscription information, the telecommunications platform receives (at step 504) the audio message and the selection of the one or more intended destinations. The telecommunications platform stores the received audio message in a first database at step 506. In some embodiments, the telecommunications platform assigns an identifier to the audio message at step 508. The telecommunications platform stores the identifier in a second database at step 510. In some embodiments, the second database can be the same as the first database or included inside the first database. The telecommunications platform retrieves the identifier from the second database and inserts the identifier in a queue, at step 512. After retrieving (at step 514) the audio message from the first database, the telecommunications platform communicates (at step 516) the audio message to the one or more intended destinations. In some embodiments, steps 512, 514, and 516 are performed by a queue worker which collects the identifier, audio message, and other information from the queue. The process terminates thereafter. In some embodiments, the destination can be at least one of: a landline phone, a cell phone, a soft phone such as a VoIP phone, a website hosted by the telecommunications platform or a third party, or a social media network.

Embodiments of the present disclosure include various steps. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present disclosure may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), field programmable gate arrays (FPGAs), application-specific integrated circuits (ASICs), vehicle identity modules (VIMs), magnetic or optical cards, flash memory, or other type of media/machine-readable medium suitable for storing electronic instructions.

Moreover, embodiments of the present disclosure may also be downloaded as a computer program product or data to be used by a computer program product, wherein the program, data, and/or instructions may be transferred from a remote computer to a requesting computer by way of data signals embodied in a carrier wave or other propagation medium via a communication link (e.g., a modem or network connection).

1. A computer-implemented method performed by a server comprising:
prompting a user for subscription information, an audio message, and a selection of one or more intended destinations for delivery of the audio message;
upon successful verification of the subscription information, receiving the audio message and the selection of the one or more intended destinations from the user;
storing the audio message in a first database;
assigning an identifier to the audio message ;
storing the identifier in a second database; and
by a queue worker:
retrieving the identifier from the second database and inserting the identifier in a queue,
retrieving the audio message from the first database, and
communicating the audio message to the one or more intended destinations.

2. The computer-implemented method of claim 1, wherein the audio message is received via a telephony instance further comprising:
upon determining that a number of visitors to a webpage hosted by the server is increasing, deploying additional web instances and reducing the count of telephony instances and vice-versa.

3. The computer-implemented method of claim 2, wherein a total count of the web instances and the telephony instances are fixed.

4. The computer-implemented method of claim 1, further comprising:
receiving, from the user, a sequence of the delivery of the audio message to the one or more intended destinations; and
determining, via the queue worker, the sequence of the delivery of the audio message to the one or more intended destinations.

5. The computer-implemented method of claim 1, further comprising:
receiving parameters defining preferences of the user;
configuring a data structure instance based on the received parameters.

6. The computer-implemented method of claim 1, wherein the audio message is received via a mobile application running on a computing device of the user.

7. The computer-implemented method of claim 1, wherein the audio message is received via a website hosted by the server.

8. The computer-implemented method of claim 1, wherein the one or more intended destinations includes at least one of: a landline phone, a cellular phone, a soft phone, a social media network.

9. The computer-implemented method of claim 1, further comprising:
provide, to the user, a display option for entering a caption to the audio message.

10. The computer-implemented method of claim 1, wherein the display option is a title or a descriptor text box.

11. An apparatus, comprising:
prompting a user for subscription information, an audio message, and a selection of one or more intended destinations for delivery of the audio message;
upon successful verification of the subscription information, receiving the audio message and the selection of the one or more intended destinations from the user;
storing the audio message in a first database;
assigning an identifier to the audio message;
storing the identifier in a second database; and
by a queue worker:
retrieving the identifier from the second database and inserting the identifier in a queue,
retrieving the audio message from the first database, and
communicating the audio message to the one or more intended destinations.

12. The apparatus of claim 11, wherein the audio message is received via a telephony instance further comprising:
upon determining that a number of visitors to a webpage hosted by the server is increasing, deploying additional web instances and reducing the count of telephony instances and vice-versa.

13. The apparatus of claim 12, wherein a total count of the web instances and the telephony instances are fixed.

14. The apparatus of claim 11, further comprising:
receiving, from the user, a sequence of the delivery of the audio message to the one or more intended destinations; and
determining, via the queue worker, the sequence of the delivery of the audio message to the one or more intended destinations.

15. The apparatus of claim 11, further comprising:
receiving parameters defining preferences of the user;
configuring a data structure instance based on the received parameters.

16. A non-transitory computer-readable medium, comprising:
prompting a user for subscription information, an audio message, and a selection of one or more intended destinations for delivery of the audio message;
upon successful verification of the subscription information, receiving the audio message and the selection of the one or more intended destinations from the user;
storing the audio message in a first database;
assigning an identifier to the audio message;
storing the identifier in a second database; and
by a queue worker:
retrieving the identifier from the second database and inserting the identifier in a queue,
retrieving the audio message from the first database, and
communicating the audio message to the one or more intended destinations.

17. The computer-readable medium of claim 16, wherein the audio message is received via a mobile application running on a computing device of the user.

18. The computer-readable medium of claim 16, wherein the audio message is received via a website hosted by the server.

19. The computer-readable medium of claim 16, wherein the one or more intended destinations includes at least one of: a landline phone, a cellular phone, a soft phone, a social media network, a website hosted by a third party.

20. The computer-readable medium of claim 16, further comprising:
provide, to the user, a display option for entering a caption to the audio message.
